(19) United States
(12) Patent Application Publication
(10) Pub. No.: US 2007/0259718 A1
(43) Pub. Date: Nov. 8, 2007

(54) Method and system for providing group interactive control of a shared digital entertainment environment using telephones and telecommunications networks

(76) Inventor: Julian Bleecker, Venice, CA (US)

Correspondence Address: Julian Bleecker, 613 Angelus Place, Venice, CA, 90291-4916, US

(21) Appl. No.: 11/279,943

(22) Filed: Apr. 17, 2006

(51) Int. Cl. G06F 19/00

(52) U.S. Cl. 463/41

(57) ABSTRACT

A method and system is disclosed for interacting in a game or entertainment experience in which participants in the game are located in the same physical space and use telecommunications networks and telephones. The game consists of actions initiated by game participants through their pressing numerical or symbolic keys on their telephones, or speaking into their telephones, so as to control or initiate action within the game.

Method and system for providing group interactive control of a shared digital entertainment environment using telephones and telecommunications networks.

### BACKGROUND OF THE INVENTION

This invention relates generally to telecommunications methods and, more particularly, relates to techniques for operating a plurality of wireless telecommunications devices, such as cellular telephones, to control or initiate action in a shared, electronic, computer-controlled game while participants in the game are physically co-located, such as while all participants are occupying an auditorium, sports arena, concert hall or other venue in which those engaging the activity may be considered physically proximate.

### PRIOR ART

Corporate entities often use games and contests to promote their goods and services. For example, product companies, such as soft drink beverage companies, often sponsor contests, events, or games to entice the public to consume their beverages with the chance of winning a prize for their participation in the event or game.

Oftentimes, these contests or games are delivered at entertainment venues such as concerts, casinos, or movie theaters, where the general population of visitors or venue audience members are all candidate participants. For example, movie theaters often use the time prior to showing the feature film to offer a simple slide show of movie trivia questions, followed by answers, to keep patrons entertained before the featured movie begins. In such simple movie trivia contests, participation is largely non-interactive or silent. In this sense, individual audience members may only test themselves or their immediate neighbors as to the correct answer. There are often no mechanisms for registering one's guess so as to compare one's performance with the larger audience as a whole, and thus turn the trivia game into a group entertainment activity.

The increase in the number of mobile and wireless personal communications devices such as mobile phones, together with the advent of robust digital projection systems that can display digital media produced by an attached data processing units, such as a computer, provides new possibilities for richer interactive experiences. For example, one or a plurality of mobile phones could possibly use telecommunications messaging systems to control processes, such as a game running on a computer, or a special-purpose game or entertainment console device. That computer could then, in principle, process the control input from the mobile phones, change the state of a game or other software programs it may run, and then display the updated state using audio systems and video display systems that all participants at or near the display systems could hear and observe simultaneously.

One of the requirements of interactive systems such as games or software in which a user provides an input followed by action or output by the computer, is that the control input produce a response with minimal delay. For example, pressing the button on a computer mouse works as a satisfactory control input because the effect of the mouse button press is immediately observable to the user. The efficacy of interactive systems is based upon their ability to process control inputs with minimal delay.

Present methods for controlling interactions for a system, such as the trivia game scenario described above, typically use techniques for which there is a significant time delay between a participant deciding what control input they would like to initiate, forming the control input by pressing a button or buttons, and then dispatching it to the processing unit running the software. For example, existing systems attempt to use mobile phones that are able to send email, instant messaging, or short message service (SMS) inputs for which there can be a consequential and unpredictable time delay. This time delay prohibits the creation of game experiences where there is an optimally minimized delay between a control input and the result of the input affecting some aspect within the game.

It is the state of the art in digital interactive systems that there is an optimally minimal delay between pressing a button, such as that on a mouse, and having the result of that control input reflected in the state of the software acted upon. For games and other entertainment experiences where it is desirable to have a minimal delay, the unpredictable and potentially long time delays associated with SMS, instant messaging or email can make the game experience unsatisfying to users whose expectations are dictated by the current state of the art in responsiveness of digital entertainment systems. Thus, an unpredictable and relatively long delay mitigates against certain desirable classes of highly interactive game designs.

Further, other known systems require the use of specialty software running on the telephone, typically a mobile telephone, such as may be downloaded to the telephone and run on a data processing unit that supports the telephone's functionality. Given the incompatibilities between mobile telephones as exists in the current mobile telephone marketplace, specialty software limits the possibilities for participation by a plurality of candidate participants, or audience members. Insofar as the public at large has a large diversity of models and makes of mobile phones with a large diversity of capabilities, the likelihood of participation diminishes as not all candidate participants will have telephones compatible with whatever specialty software is required for engaging the game or interactive experience.

### OBJECTS AND ADVANTAGES

The present invention has distinct advantages over systems and methods that use message delivery techniques such as SMS, email or instant messaging. The time delays that these systems and methods incur in transporting a user's control input to a computer that can accept the message and alter the state of a digital interactive experience mitigates against the design of a desirable class of highly interactive experiences.

Further, the present invention has distinct advantages over systems and methods that use electronic hardware or data processing software features particular to specific models of telephones, particularly mobile telephones. In other existing implementations of systems that allow telephones to control the kind of interactive systems described in the embodiments of this invention, the telephone is required to have features beyond those of conventional telephony communications, such as Bluetooth radios, 802.11 “WiFi” radios, or other embedded electronics that are not typically present nor considered the basic features necessary to conduct telephone communications. These techniques, device characteristics and features these existing systems require are particular to a limited range of specific makes and models of telephones. Thus, these techniques are limited in that some users' telephones may not contain the necessary features to take advantage of telephone-based control of the kind of interactivity described as the embodiments of this invention. As described above, the disadvantage of these specialty electronic hardware or data processing software approaches is that not all candidate participants will have devices containing or compatible with the specialty features.

In summary, existing systems and methods either exhibit time delays significant enough to make a class of highly interactive entertainment intractable, or require the use of specialty software or hardware that may not be supported by a large enough proportion of candidate participants to make the system a viable form of entertainment.

Thus, it would be an advancement in the art to provide a method for user-controlled interaction with a network connected data processing unit (such as a network connected computer) such that the delay between initiating the user-controlled action on the telephone and the effect of that action were minimized beyond what the current systems and methods provide. It would be a further advancement in the art to develop a method to transmit these control inputs to the network connected computer that used functionality that exists on all telephones.

### SUMMARY

This invention describes a system which augments the functionality of a telephone to allow users to control a networked computer by either or both pressing the telephone's keypad and speaking voice commands. The ubiquity of telephones as communications devices, especially mobile wireless or cellular telephones, means that the present invention provides a mechanism for controlling networked computers in a variety of usage scenarios. The present invention uses the basic functionality provided by telephones. That is, the invention relies solely upon the ability to place calls, to transmit audio signals through key presses that generate dual-tone multi-frequency (DTMF) tones, to transmit voice commands in the form of an audio signal, and the ability to receive audio signals in the form of tones and speech.

### BRIEF DESCRIPTION OF THE DRAWINGS

The foregoing and other aspects of these teachings are made more evident in the following Detailed Description, when read in conjunction with the attached Figures, wherein:

FIG. 1 is an illustrative schematic diagram of a primary embodiment of the present invention.

FIG. 2 is an illustrative schematic diagram of an alternative embodiment for the present invention, indicating the association of a persistent storage apparatus such as a relational database management system (RDBMS).

FIG. 3 is an illustrative schematic diagram of an alternative embodiment for the present invention, indicating the association of a connected peripheral device such as a lighting system control device.

### DETAILED DESCRIPTION

### Preferred Embodiment

This invention provides a method for using one or more telephones as control input devices for controlling the activities of a network connected computer. The telephones use only the basic functionality of a conventional telephone. Such basic functionality is that which any conventional telephone, without modifications or without regard to features offered by specific telephone device models, such as the capability to process and run special purpose software that is incompatible with other telephone makes or models, or features and functionality proprietary to the capabilities of one or several makes or models of telephone devices.

The method includes (a) dialing a specific telephone number connected via telecommunications networks to a telephony gateway such as a VXML gateway that interprets and processes audio signals generated by the individual telephones and; (b) using the interpreted audio signals to generate a data message containing information about the specific telephone's automatic number identification (ANI) and the specific dialing number keys pressed by that telephone, and; (c) transmitting the data message over telecommunications networks to a data processing unit such as a network connected computer that contains software programs that interpret the data message and changes the behaviors of software running on the networked connected computer according to the interpreted semantics of the data message.

The teachings of this invention provide in one aspect an entertainment application utilizing the controlled key presses of a plurality of individual telephones in a coordinated fashion to interactively control an entertainment game experience running as software on a network connected computer. The results of these controlled key presses is to change the state or character of the game as depicted on either or both of a visual display and audio output system connected to the networked computer.

The teachings of this invention provide in another aspect an improved user interface application by which a telephone device, such as a cellular or mobile telephone, is able to control the general state of a network connected computer, through the delivery of signals generated by those key presses over telecommunications networks.

The teachings of this invention provide in another aspect a method for capturing and logging in a persistent storage and retrieval mechanism, such as an information database, the telephone calls' ANI's and the sequence of controlled key presses for individual telephones. Such captured and logged information pertaining to the activities of participants may be used to extend the features of the game across multiple game sessions, or to provide mechanisms for fulfilling game rewards.

In another aspect of the method of this invention, the telephony gateway and the data processing unit may be a single combined unit such as the state of the art in technology affords such capabilities.

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

In the following description of the preferred embodiment, reference is made to the accompanying drawings which form a part hereof, and which show by way of illustration various embodiments in which the invention may be practiced. It is to be understood that other embodiments may be utilized and structural and functional modifications may be made without departing from the scope of the present invention.

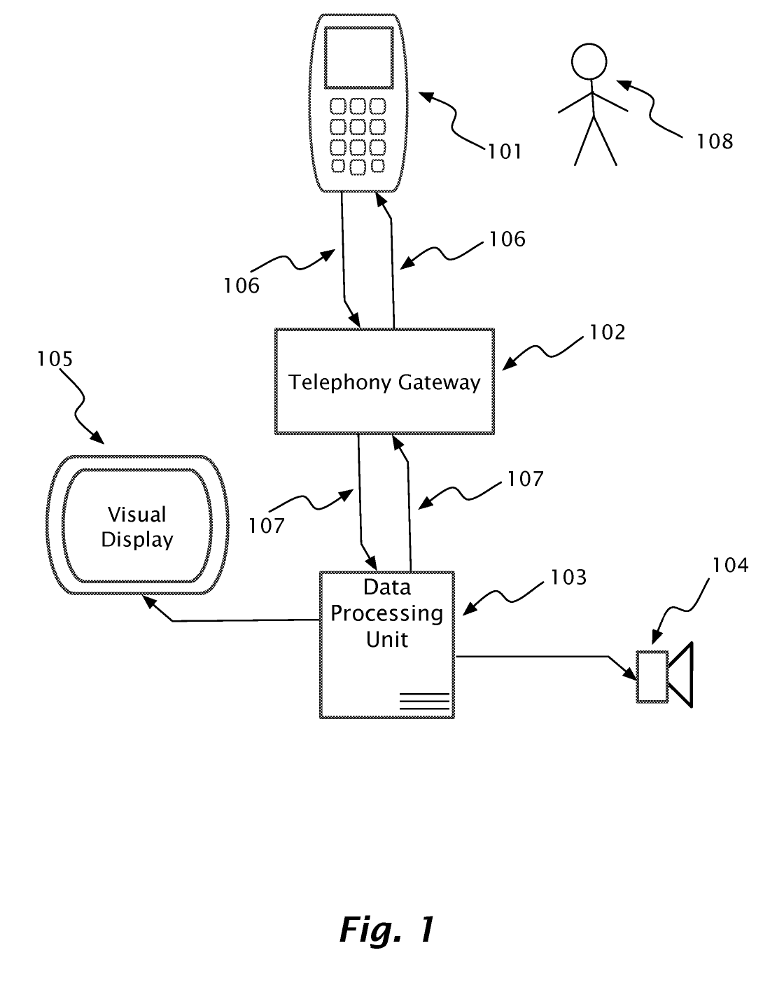

Operation—FIG. 1

FIG. 1 illustrates a telephony solution in accordance with the primary embodiment of the present invention. The system includes telephone 101, telephony network gateway 102, data processing unit 103, audio output system 104, visual display output system 105, a telecommunications network 106, a telecommunications network 107, and a user 108 who operates telephone 101. For the purposes of clarity, FIG. 1 indicates a single user 108 with access to a single telephone 101. In the preferred embodiment, there may be a plurality of users each with access to their own individual telephones.

Telephone 101 can be any telephone including cellular telephones and their associated cellular mechanisms or any IP-based telephony device such as a voice over IP (VOIP) terminal that can be connected to the telephony network gateway 102.

Telephony network gateway 102 can be any system that bridges the network communication link from telephone 101 to data processing unit 103, including a VOIP gateway or VXML gateway.

Telecommunications network 106 can be any network link that can connect telephone 101 to telephony gateway 102, including a public switched telephone network (PSTN), cellular telephone network, or IP networks such as the Internet.

Telecommunications network 107 can be any network link that can connect telephony network gateway 102 to data processing unit 103, including IP networks such as the Internet.

The system operates generally as follows, and as illustrated in FIG. 1. An individual or plurality of users, indicated as a single user 108, each initiate a telephone call using their telephone, indicated as a single telephone 101 in FIG. 1. The initiation of the call connects telephone 101 to telephony network gateway 102. Telephony network gateway 102 can be directed to send control messages to data processing unit 103 based upon the dial pad keys that user 108 presses on telephone 101 while telephone 101 is connected to telephony network gateway 102. Similarly, telephony network gateway 102 can be directed to send control messages to data processing unit 103 based upon the articulation of speech by user 108 into telephone 101. Based on the interpreted semantics of these control messages, data processing unit 103 will adjust either or both of the visual display output system 105 and audio output system 104, through the capabilities of software programs that run on data processing unit 103. These software programs may also send control messages back to telephony gateway 102 which can be further directed to produce an audio signal on telephone 101 in response to the input or based upon the state of the software programs.

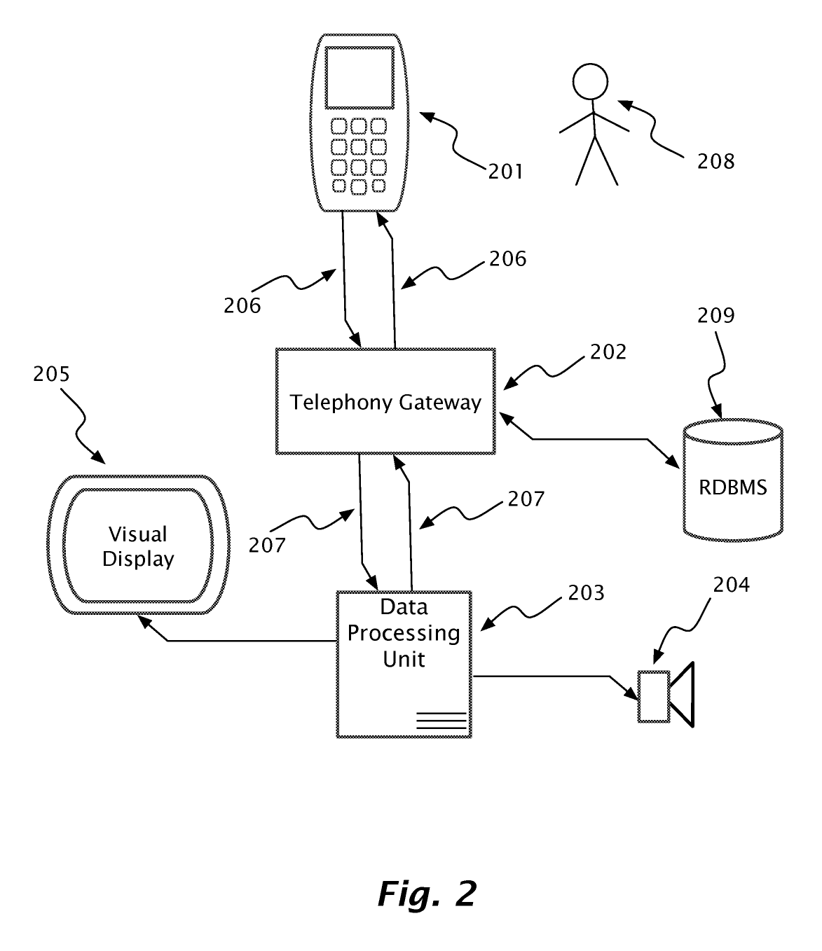

Operation—FIG. 2

FIG. 2. illustrates an alternative embodiment in which telephony network gateway 202 is linked to a data storage mechanism 209, such as a relational database management system (RDBMS) that persists the sequence of key presses for individual telephone calls into the system, including the automatic number identifier (ANI) linked to that sequence of key presses. A similarly related alternative embodiment would contain an RDBMS attached to either or both telephony network gateway 202 and data processing unit 203 to perform similar functionality as aforementioned.

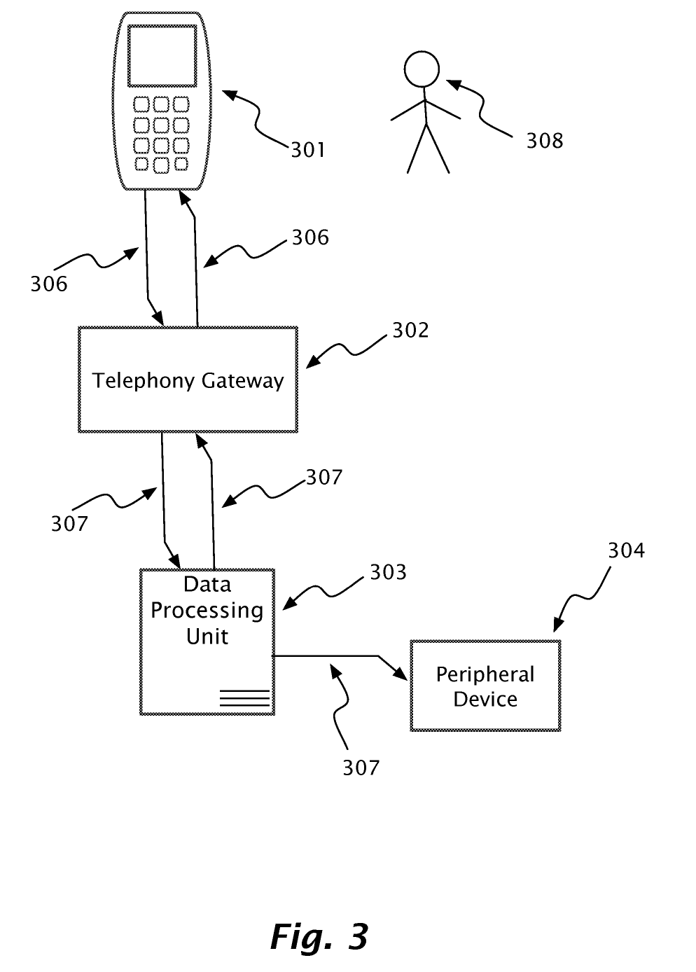

Operation—FIG. 3

FIG. 3. illustrates another alternative embodiment in which data processing unit 303 runs software that interfaces with one or a plurality of peripheral devices 304, such as mechanisms to control other aspects of the entertainment experience, such that control inputs initiated by user 408 through telephone 301 may control the behavior of those peripheral devices. Such peripheral devices might include systems to control lighting displays, for example. This aforementioned peripheral device can be linked to data processing unit 303 through a variety of communications links such as afforded by the current state of the art, such as IEEE1394 “Firewire” network communication protocols or RS232 serial communications protocols.

In alternative embodiments, the system does not include the audio output system 104 or audio output system 204 or the visual display output system 105 or the visual display output system 205, but retains the other system features.

### CONCLUSION, RAMIFICATIONS AND SCOPE

The foregoing and other problems of the current methods and systems are over-come, and other advantages are realized, in accordance with the presently preferred embodiments of these teachings. A method is herewith provided to deliver to a data processing unit over telecommunications networks the control input derived from speaking into a telephone, or pressing a numeric or symbolic key on a telephone with optimally minimized delay, such that the generic and conventional functionality of telephone is sufficient to execute such control.

The foregoing entertainment applications used to describe the primary embodiments are intended to be merely representative of the utility of this invention, and are in no way to be viewed as limitations on the use of the invention. Those skilled in the game programming arts are assumed to have the expertise to create alternative game applications, scenarios and entertainment experiences that are executed by the data processing unit (e.g. 103 in FIG. 1, 203 in FIGS. 2 and 303 in FIG. 3). The specifics of the play of the game or entertainment experiences are not germane to an understanding of this invention, except as to the use of the aforementioned method and embodiments for interacting with the game application.

While the invention has been described with respect to specific examples including presently preferred modes of carrying out the invention, those skilled in the art will appreciate that there are numerous variations and permutations of the above described system and methods that fall within the spirit and scope of the invention as set forth in the appended claims.

What I claim as my invention is:

1. A method for using a telephone to control input/output interactions with a networked data processing unit, such as a conventional networked computer, comprising:
a telecommunications network; a telephony network gateway; an internet protocol (IP) network such as the Internet that is connected to the telephony network gateway and to the data processing unit. The telecommunications network is coupled to the telephony network gateway through the initiation of a telephone call. The telephony network gateway is configured so as to deliver messages to the data processing unit that correspond to the specific audio signals generated by such as key presses and speech from the telephone so as to initiate actions on the data processing unit.

2. The method of claim 1 wherein the telecommunications network includes a wireless carrier.

3. The method of claim 2, wherein the wireless carrier includes a cellular digital packet network.

4. The method of claim 2, wherein the wireless carrier includes a code division multiple access network.

5. The method of claim 2, wherein the wireless carrier includes a global system for mobile communications network.

6. The method of claim 2, wherein the wireless carrier includes a general packet radio service network.

7. The method of claim 2, wherein the wireless carrier includes a 1xEVDO data transport

8. The method of claims 1 and 2 wherein the communications network includes an IP network system.

9. The method of claim 7, wherein the IP network system includes voice over IP network (VOIP)

10. The method of claim 2 wherein the communications network includes a public switched telephone network (PSTN).

11. The method of claim 1 wherein the key press audio signals generated are dual-tone multi-frequency (DTMF).

12. The method of claim 1 wherein the telephony gateway is a voice extensible markup language (VXML) gateway.

13. The method of claim 1 wherein the telephony gateway is a voice over IP (VOIP) gateway.
